(19) United States
(12) Patent Application Publication
(10) Pub. No.: US 2001/0034162 A1
(43) Pub. Date: Oct. 25, 2001

(54) Connector with prestressed contacts and its use

(75) Inventors: Jacques Annaler, Pontarlier (FR); Michel Garcin, Pontarlier (FR)

Correspondence Address: PERMAN & GREEN, 425 POST ROAD, FAIRFIELD, CT, 06430, US

(73) Assignee: Framatome Connectors International Courbevoie

(21) Appl. No.: 09/825,542

(22) Filed: Apr. 3, 2001

Related U.S. Application Data
(63) Continuation-in-part of application No. 09/455,585, filed on Dec. 6, 1999, now abandoned.

(30) Foreign Application Priority Data
Dec. 10, 1998 (FR) FR98/15618

(51) Int. Cl. H01R 24/00

(52) U.S. Cl. 439/630

(57) ABSTRACT

In order to increase the precision of the definition of a contact by pressure between a connector (1), designed to be surface-mounted, and a smart card, one assures a support plane for the connector, this latter on a flat printed circuit. This support plane is created by means of vertical prestresses on elastic conductive strips (3, 4, 5, 6, 7, 8) of the connector. This vertical prestress consists of pressing one end (11, 12, 13) of the elastic conductive strips onto fixed pieces (14, 15, 16, 17) aligned in a plane. This improvement makes such a connector easy to use and makes it possible to have a statistical inspection of the quality of the connectors thus made.

### RELATED APPLICATIONS

This application is a continuation-in-part of application Ser. No. 09/455,585, filed Dec. 6, 1999 and titled: “CONNECTOR WITH PRESTRESSED CONTACTS AND ITS USE”

### BACKGROUND OF THE INVENTION

I. Field of the Invention

The present invention relates to a connector with prestressed contacts and its use, and more particularly to a connector having vertically prestressed contacts. A connector in accordance with the features of the present invention has elastic conductive strips provided with contact pins that are to be soldered, and an insulating structure in which the elastic conductive strips are supported. The invention particularly finds application in mounting connectors on a printed circuit board (PCB), such as, for example, in the surface mounting of connectors designed to assure an electrical connection between microcircuits of a smart card and of electronic systems. These electronic systems are, in a preferred example, those of smart card readers or mobile telephones. This type of connector has elastic conductive strips designed to assure electrical contacts by pressure with metallic surfaces or contact areas present on the smart card. Moreover, the contact between the connectors contact pins that are to be soldered and the surface of the printed circuit on which these pins must be soldered, must be a flat contact. The invention also relates to an improvement in the coplaneity [inherent flatness] of the electrical contact between any contact pin that is to be soldered and the surface of the printed circuit. In accordance with the features of the present invention a coplaneity of less than 0.02 mm is obtained by vertically prestressing each contact pin that is to be soldered.

II. Description of the Prior Art

Connectors designed for surface mounting that are currently manufactured have contact pins that cure to be soldered. One free end of the pin is chamfered to form a contact plane with the printed circuit. Each contact pin that is to be soldered defines a local contact plane designed to come into contact with the printed circuit. Taking into account all the planes of local contact defines a distribution, in the direction of the thickness, of connector contacts with regard to the plane of the printed circuit. In fact, during the manufacture of a connector, the chamfering of the elastic conductive strips is produced according to processes which do not easily permit obtaining a good repeatability with regard to the coplaneity of the contact pins to be soldered (surface mounting). Thus, appreciable differences of form and/or dimensions may exist between two elastic conductive strips. On the one hand, one contact pin of a strip that is to be soldered may not be perfectly planar. On the other hand, two contact pins that are to be soldered, each one of which may be planar, may have different contact planes and/or contact planes that are not parallel to one another. This type of connector thus presents problems.

In a general manner, the connector described above is comprised of a thermoplastic insulating structure and a certain number of bronze contacts; e.g. six in one example. These contacts are treated and receive a triple coating of nickel, then tin-lead, and finally a layer of gold for the part in contact with a smart card. The pins of these contacts are designed to be surface-mounted on a printed circuit board. In this type of design, the contact assembly of the connector must adequately assure a sufficient contact pressure for good electrical transmission.

In fact, a smart card connector, for example, belonging to a mobile telephone or any other electronic system likely to be subjected to vibrations, will transmit these vibrations to the smart card as well as to the connector. In this case, a lowering of the contact pressure on the smart card is problematic, since, if a vibration is too strong, a contact between the smart card and the connector can be interrupted or defective, even for a brief instant, which can lead to reading or writing errors of data in the smart card.

Thus, in order for there to be a satisfactory contact with a smart card, it is necessary that the support plane of the connector's contact pins that are to be soldered be merged or at least quasi-merged with the contact plane of the printed circuit. This “coplanarity” permits effectively conforming to a requirement called coplaneity [inherent flatness] necessary for implementing the process for surface mounting, (i.e.,CMS), a requirement that implies that any contact must be found within a maximum tolerance range, which is desirably small, relative to a support plane of the connector's contact pins that are to be soldered on the printed circuit, a support plane that defines a reference plane for the coplaneity.

Furthermore, the size constraints of the connector do not permit a sufficiently precise guidance of the contact pins that are to be soldered. This implies that the support plane cannot be determined in a precise and reproducible manner and therefore, a significant dispersion with regard to coplaneity is brought about.

More precisely, in order to assure an effective CMS soldering, the outlets of the components, i.e., the contact pins that are to be soldered, must be designed to permit guaranteeing a coplaneity of less than 0.1 mm. This is translated into reality by a dimension X, representing a distance between the support face of the insulator of the component and the face to be soldered of the CMS outlets, whose tolerance range is 0.1 mm (X±0.05 mm).

This dimension X results from a double chamfering of an elastic conductive strip (the contact zone with the smart card must be elastic) and it is the elasticity of this elastic conductive strip which is the cause of most of the problems encountered as defined above. This elasticity varies as a function of the material used to create an elastic conductive strip, its thickness, or even the surface treatment applied. Thus, there are too many influences to assure obtaining, by mass production, elastic conductive strips with a tolerance of less than approximately 0.05 millimeter.

Moreover, this problem leads to another problem. In fact, knowing that the coplaneity of the printed circuit with the contact plane has a high probability of being imperfect provides for the need for each connector to be inspected. In addition to the number of rejections this entails, this piece-by-piece inspection is as lengthy as the number of connectors is large, which creates a loss of time. This results in an increase in the overall cost of such a connector.

### SUMMARY OF THE INVENTION

A primary objective of the present invention is to remedy the problems cited by proposing a connector having an insulating structure and a multiple number of elastic conductive strips, held in this structure, each strip being provided with a contact pin that is to be soldered. The insulating structure has fixed pieces aligned in a plane. The contact pins that are to be soldered are supported on these fixed pieces in this plane by the effect of a vertical prestress that is applied to them. Thus, the contact surface of the contact pins that are to be soldered is found pressed into the plane of the fixed pieces, with a precision of the order of 0.02 mm, given that molding of insulators with such precision is known. As a result of this, the contact between the connector's contact pins that are to be soldered and the printed circuit board surface is a perfectly flat contact. Thus, the contact zones of the elastic strips with the smart card is also found in a plane perfectly parallel to the contact plane of the smart card.

The invention therefore concerns a connector having an insulating structure and a multiple number of elastic conductive strips, held in this insulating structure, each elastic conductive strip being provided with a contact pin to be soldered, wherein the contact pins that are to be soldered are vertically prestressed and that the insulating structure has fixed pieces aligned in a plane on which the prestressed contact pins press.

In accordance with the preferred features of the present invention a connector includes an insulating structure and a plurality of elastic conductive strips, each of the strips having a first lower end portion forming a contact pin and a second upper end portion and each strip being positioned within the insulating structure. Each contact pin is adapted to be soldered to a surface, and each contact pin being vertically prestressed, thereby resulting in coplaneity of each contact pin that is to be soldered, the insulating structure including fixed pieces aligned in a single plane and adapted to press the vertically prestressed contact pins into contact with the surface thereof.

In accordance with the features of the present invention a coplaneity of less than 0.02 mm is obtained by vertically prestressed contact pins.

### BRIEF DESCRIPTION OF THE DRAWINGS

The accompanying drawings, which are incorporated in and constitute a part of the specification illustrate one embodiment of the invention and, together with the description, serve to explain the principles of the invention.

FIG. 1: a perspective view of the connector according to the invention;

FIG. 2: a perspective view of an elastic conductive strip of the connector according to the invention;

FIG. 3: a plan view of an anchoring plate of the elastic conductive strip with its two lateral arms; and

FIG. 4: a sectional view of the connector according to the invention.

### DETAILED DESCRIPTION OF THE PREFERRED EMBODIMENTS

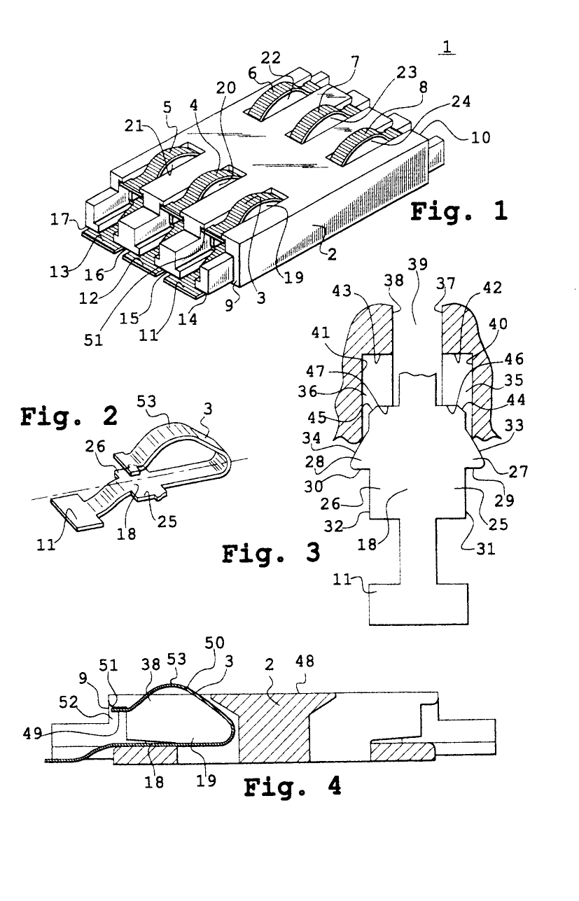

FIG. 1 illustrates a connector 1 according to the features of the present invention. The connector I includes an insulating structure 2 and, in one preferred example, six elastic conductive strips 3, 4, 5, 6, 7, and 8. The strips are distributed by groups of three, symmetrically and regularly, along the two opposite sides 9 and 10 of insulating structure 2,. The following description will limit the description to the elements situated on side 9. However, the elements on side 10 can be deduced from the description of side 9 by symmetry.

The conductive elastic strips 3, 4, 5, respectively on side 9, are provided with contact pins 11, 12, 13 on each lower end portion of each strip respectively to a printed circuit board (not shown). In one a preferred example, these contact pins that are to be soldered to a printed circuit board are in the form of flat plates and situated at a first lower end portion of each of strips 3, 4 and 5, respectively. In addition, these contact pins 11, 12 and 13 that are to be soldered are preferably arranged perpendicularly to side 9 of insulating structure 2. In addition, insulating structure 2 includes fixed pieces 14, 15, 16 and 17 regularly aligned in a plane. This plane is preferably perpendicular to side 9. The contact pins 11, 12, 13 that are to be soldered have a generally “T”-shaped widening configuration. These T-shaped widenings, are derived from contact pins 11, 12, 13 being supported under fixed pieces 14, 15, 16 and 17 in the manner illustrated in FIG. 1. To accomplish this configuration, each contact pin 11, 12, 13 is situated between two fixed elements 14-15, 15-16, and 16-17 respectively. In one preferred example, fixed elements 14,15,16 and 17 are structures rising perpendicularly to side 9 and have at least one flat face. These flat faces are those under which the contact pins 11,12 and 13 are supported. These fixed elements are substantially rigid, so that the pressures applied by the contact pins that are to be soldered are insufficient to deform the support planes of the fixed elements 14, 15, 16 and 17. Thus, the widenings 11A and 11B of the contact pin 11 are supported by two fixed elements 14 and 15 and the widenings 12A and 12B of contact pin 12 is supported by two fixed pieces 15 and 16 and so on. The plane of fixed pieces 14, 15, 16 and 17 is by design (molding) obtained within the tolerance sought.

FIG. 2 illustrates conductive elastic strip 3 in a position removed from connector 1. Strip 3 includes an anchoring plate 18 placed in an intermediate position. This intermediate position is a position in which anchoring plate 18 is closer to the end of strip 3 with contact pin 11. Anchoring plate 18 (see FIG. 1) is forcefully inserted into opening 19 positioned in insulating structure 2. Insulating structure 2 also has openings for the other elastic conductive strips 4, 5, 6, 7 and 8. In the example shown, insulating structure 2, therefore, has six openings 19 to 24. The forceful insertion of anchoring plate 18 into housing 2 permits assuring a fixed bond between anchoring plate 18 and insulating structure (housing) 2. Anchoring plate 18 projects laterally having two lateral arms 25 and 26. The forceful insertion of anchoring plate 18 into opening 19 in insulating structure 2 has the effect of inserting the two lateral arms 25 and 26 into two lateral grooves (not shown) in housing 2.

Contact pin 11 is vertically prestressed so as to be positioned to be pressed onto fixed pieces 14 and 15 once the strip 3 is inserted within housing 2. Each contact pin is vertically prestressed against the fixed pieces by an upwardly ducted vertical force resulting from the bending of strip 3 and anchoring plate 18. Each strip (3, 4, 5, 6, 7 and 8) comprises two opposite portions, i.e. a vertically prestressed lower portion and an upper portion. It is the lower vertically prestressed portion of each strip that is responsible for the coplaneity of less than 0.02 mm. This coplaneity is obtained by an upward vertical force that each upper surface of each contact pin (11,12 and 13) applies directly on shoulders 14, 15, 16 and 17 on insulting structure 2. There is clearly a distinction between the lower portion of each strip which is vertically prestressed, and the upper portion of each strip (also prestressed against edges 51—See FIG. 4—but not responsible for the coplaneity advantage). The prestress of the upper portion of each strip ensures a good enough degree of contact between the top portion of each strip and a PCB such as a smart card.

The vertically prestressed state of each lower portion of each strip is obtained through the bending of the strip illustrated in FIG. 2 (around the inflexion zone between the contact pin 11 and the anchoring plate 18) when the achoring plate is placed into walls 37 and 38 of housing 39 (See FIG. 3). This results into the T shaped contact pins being pressed against the bottom of shoulders 14 to 17 and therefore the coplaneity of less than 0.02 mm.

This opposition of fixed pieces 14 and 15 therefore maintains the deformation of elastic conductive strip 3, which, while being permanent, remains an elastic deformation. The vertically prestressed condition of each lower portion of each strip permits assuring the contact of each contact pin to be soldered (e.g. 11) on fixed pieces (e.g. 14 and 15). It is fixed pieces 14, 15, 16 and 17 on side 9 of insulating structure 2 that are opposed to the reaction forces applied by contact pins 11, 12 and 13.

Insulating structure 2 is obtained, in a preferred example, by a molding process. The molding processes used currently permit obtaining flat surfaces and dimensions with a precision of the order of 0.02 mm (i.e., one can obtain surfaces whose relief variations are contained in a space whose thickness can be reduced to approximately 0.02 mm).

In accordance with the features of the present invention the elastic properties of the strip are used. In fact, during support of the contact pins on the fixed pieces, the reaction force is sufficient to obtain a deformation of the contact pins to be soldered, so that a contact between a contact pin and a fixed piece is flat. Thus, the planeity obtained in the case of the invention for contact pins to be soldered 11, 12 and 13 is greater than the planeity obtained in the state of the art.

FIG. 3 illustrates anchoring plate 18 provided with two lateral (attachment) arms 25 and 26. The two attachment arms 25 and 26 are extended, in parallel to a plane passing through anchoring plate 18, by two lateral attachment catches 27 and 28, respectively. A lateral attachment catch 27 or 28 has a form of a harpoon or wedge, a first side 29 or 30 of which is perpendicular to an end 31 or 32 of one of lateral arms 25 or 26, respectively. A second side 33 or 34 is oblique with regard to end 31 or 32, respectively. Catches 27 and 28 are arranged such that, with regard to the direction of insertion of anchoring plate 18, it is oblique sides 33 and 34 of catches 27 and 28 which first penetrate into grooves 35 and 36, respectively, provided for this purpose in walls 37 and 38 of a housing 39. Sides 29 and 30 of catches 27 and 28 penetrate in second place.

At the beginning of insertion of lateral arms 25 and 26 into grooves 35 and 36, catches 27 and 28 penetrate into walls 40 and 41 of grooves 35 and 36 respectively, facing one another. Thus the two catches 27 and 28 deform walls 40 and 41 under the effect of an insertion force applied to anchoring plate 18. This deformation of walls 40 and 41 has for an effect producing a compression stress on catches 27 and 28 and therefore attaching anchoring plate 18. At the end of insertion, anchoring plate 18 comes to abut walls 42 and 43 constituting a termination of grooves 35 and 36, respectively. In this state, anchoring plate 18 cannot advance further because of walls 42 and 43, nor can it laterally budge, because of the compression stresses applied by walls 40 and 41, nor can it go backwards, because of perpendicular sides 29 and 30 of catches 27 and 28 which oppose any translation movement in this direction of anchoring plate 18.

Anchoring plate 18 is therefore fixed. In addition, the two front comers 44 and 45 of anchoring plate 18 are chamfered. These two comers 44 and 45 are the angles that are formed by ends 31 and 32 of lateral arms 25 and 26 with sides 46 and 47, respectively. These sides 46 and 47 are those which, at the end of insertion of anchoring plate 18, enter into contact with walls 42 and 43 of grooves 35 and 36, respectively. These chamfered comers 44 and 45 permit favoring the engagement of anchorage 18 in grooves 35 and 36, respectively.

FIG. 4 illustrates a section of connector 1 along a sectional plane passing through elastic conductive strips 3 and 8 (conductive elastic strip 8 is not shown). In a preferred example, an opening 19 receiving conductive strip 3 has a first opening on side 9 of insulating structure 2, as well as a second opening on a side 48 perpendicular to side 9 but parallel to the contact plane of the fixed pieces.

Thus, elastic conductive strip 3, introduced in side 9 is compressed in opening 19. For this, conductive elastic strip 3 has a folded-back form and has a second end 49, which is found in a parallel plane, and not merged, with the plane passing through anchoring plate 18. A part of elastic conductive strip 3, situated between end 49 and anchoring plate 18, is chamfered in such a way that a piece of this part projects from the second opening of side 48, with a saddle-back shape 50. It is this portion of conductive elastic strip 3 which is designed to produce an electrical contact between the smart card and connector 1. This contact zone of saddle-back shape 50 with the smart card is mobile with regard to the anchoring plate.

Thus, this chamfered form of this part of elastic conductive strip 3 permits, obtaining a spring effect of a portion of this part along an axis perpendicular to side 48, when pressure is applied. This spring effect assures, in a preferred example, an electrical contact by pressure between elastic conductive strip 3 and a metal contact area on a smart card. Moreover, end 49 of elastic conductive strip 3 is subjected to a second prestress. For this, it is held, by fixed pieces between walls 37 and 38 of housing 19, at a height such that a deviation between a fixed piece 51, made in wall 38, and the plane passing through anchoring plate 18 is less than the deviation between this same plane and end 49, when it is not subjected to any stress. End 49 can therefore only move in a housing 52 in a single direction, which is opposite fixed piece 51. A T-shaped widening of end 49 of elastic conductive strip 3 permits taking support on this fixed piece 51. The latter prestress has for an objective notably to assure approximately the same contact plane for all the contact zones, this contact plane being parallel to the contact plane of the contact pins to be soldered. The deviation between a peak 53 of the saddle-back and side 48 is such that a forcing of saddle-back 50 into housing 19, resulting from pressure applied by the smart card during the connection, always leaves at least end 53 outside of housing 19. Thus the resulting reaction force assures a sufficient pressing together of the contact zones of connector 1 on the contact areas of the smart card so as to have an electrical contact by pressure according to the criteria disclosed above.

During the insertion of an elastic conductive strip 3 in opening 19 of insulating structure 2, it is necessary to resiliently bend end 49 towards anchoring Oplate 18. This permits end 49 to be inserted into housing 52. After release of the bending force, end 49 comes to abut fixed piece 51. Moreover, during insertion, contact pin 11 of elastic conductive strip 3 is placed as defined previously. In this case, elastic conductive strip 3 is subjected to two reaction prestresses with anchoring plate 18. The first prestress is that of contact pins to be soldered 11, 12 and 13 on fixed pieces 14, 15, 16 and 17. In the example, two fixed pieces are used to create a prestress on one contact pin to be soldered. Thus each contact pin to be soldered is found between two fixed pieces. A consequence of this placement of the contact pins to be soldered between the fixed pieces is that the strips are no longer mobile. Thus the risks of catching an attachment strip during the mounting operations is limited.

Insulating structure 2 is made, in a preferred example, by molding an insulating thermoplastic material. Such materials have properties of elasticity and deformation used notably during insertion of the anchorings for the conductive elastic strips as explained above. Elastic conductive strips 3 to 8 are bronze, in a preferred example, bronze being an elastic and easy-to-shape material. That is to say, it can be deformed easily. This is one of the objectives sought when the contact strips come to be supported on the fixed pieces of the insulating structure. The contact strips thus mate with the relief shape formed by the fixed pieces. Moreover, the saddle-back structure of the elastic conductive strip, assuring contact with a smart card, is coated with nickel, a tin-lead alloy and/or gold, in order to improve the contact characteristics of the elastic conductive strip and thus to favor a good electrical contact between connector 1 and a smart card.

It is also to be noted that, in general, the contact pins of CMS outlets are easily deformable and that, consequently, the fixed piece permits also assuring protection of said pins during any manipulation.

While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

1. A connector including an insulating structure and a plurality of elastic conductive strips, each of the strips having a first lower end portion forming a contact pin and a second upper end portion, and each strip being positioned within the insulating structure, each contact pin adapted to be soldered to a surface and each contact pin being vertically prestressed thereby resulting in coplaneity of each contact pin that is to be soldered, the insulating structure including fixed pieces aligned in a single plane and adapted to press the vertically prestressed contact pins into contact with the surface thereof.

2. A connector according to claim 1 wherein said contact pins comprise flat plate members positioned at each of said first vertically prestressed lower end portions.

3. A connector according to claim 2 wherein each portion of said contact pins being pressed by said fixed pieces include an enlarged portion shaped as a T.

4. A connector according to claim 1 wherein said elastic conductive strips further comprise an anchoring plate positioned in an intermediate location in said insulating structure.

5. A connector according to claim 4 wherein said anchoring plate includes lateral attachment catches on said insulating structure, each lateral corner of said anchoring plate being chamfered.

6. A connector according to claim 1 wherein said elastic conductive strips have a chamfered form and are compressed in housings within said insulating structure, said second upper end portion being prestressed in said basing.

7. A connector according to claim 6 wherein each of said elastic conductive strips have a width equal to a passage slot in said housing and said second end portion is formed as a T being supported on edges of said passage slot.

8. A connector according to claim 1 wherein each of said elastic conductive strips are formed of bronze, the contact zones of said pins and said surface are coated with nickel, a tin-lead alloy and gold, and said insulating structure is formed from a thermoplastic insulating material.

9. A connector according to claim 1 wherein said surface is a printed circuit.
